(19) United States
(12) Patent Application Publication
(10) Pub. No.: US 2025/0244612 A1
(43) Pub. Date: Jul. 31, 2025

(54) MYOPIA-CONTROLLING EYEWEAR

(71) Applicant: CooperVision International Limited, Fareham (GB)

(72) Inventors: David S. HAMMOND, Pleasanton, CA (US); Arthur BRADLEY, Bloomington, IN (US); Baskar ARUMUGAM, Dublin, CA (US); Martin WEBBER, Southampton (GB); Paul CHAMBERLAIN, Livermore, CA (US)

(73) Assignee: CooperVision International Limited, Fareham (GB)

(21) Appl. No.: 19/038,724

(22) Filed: Jan. 28, 2025

Related U.S. Application Data
(60) Provisional application No. 63/626,550, filed on Jan. 30, 2024.

(51) Int. Cl. G02C 7/06; G02C 13/00

(52) U.S. Cl. CPC G02C 7/066; G02C 13/001; G02C 2202/24

(57) ABSTRACT

Eyewear comprising a first lens and a second lens is described, as well as lenses for use in such eyewear and methods of manufacturing such lenses. The first and second lens each include an optic zone (121, 131) comprising a central region (122, 132) providing a base power and centred on an optical axis, and an outer region (123, 133) surrounding the central region (122, 132). The outer regions (123, 133) of the first lens and the second lens are complementarily arranged such that first and second subregions of the first lens (124, 125) have differing optical properties to corresponding first and second subregions of the second lens (134, 135). One of the optical properties is a myopia control stimulus and the other is an optical power for providing distance vision when the eyewear is worn.

This application claims the benefit under 35 U.S.C. § 119 (e) of prior U.S. Provisional Patent Application No. 63/626,550, filed Jan. 30, 2024, which is incorporated in its entirety by reference herein.

### TECHNICAL BACKGROUND

The present disclosure relates to eyewear, for example spectacles or contact lenses, for slowing the progression of myopia. The present disclosure also relates to methods of manufacturing lenses for use in such eyewear.

### BACKGROUND

Myopia (short-sightedness) affects a significant number of people, including children and adults. Myopic eyes focus incoming light from distant objects to a location in front of the retina. Consequently, the light diverges towards, and is out of focus upon arrival at the retina. Conventional ophthalmic lenses for correcting myopia, such as those present in eyewear such as spectacle lenses and contact lenses, cause divergence of incoming light from distant objects before it reaches the eye so that the location of the focus is shifted onto the retina. However, it is widely accepted that such lenses cannot prevent the progression of myopia. Progression of myopia may occur particularly in children and young people, where the eyes are still growing. This has led to the development of myopia-correcting eyewear, including spectacles and contact lenses, that is configured to control the progression of myopia.

Known designs of ophthalmic lenses to control the progression of myopia can include a myopia-correcting central distance region surrounded by a myopia-controlling region. In such lenses, the myopia controlling region provides a myopia control stimulus which may, for example, be defocus or contrast attenuation (without defocus). There is also evidence suggesting that manipulating the spectrum of visible light received by the retina could provide a suitable myopia control stimulus in such lenses (Gawne, T. J., Ward, A. H., Norton, T. T. (2017). Long-wavelength (red) light produces hyperopia in juvenile and adolescent tree shrews. Vision Research, 140, 55-65).

When a wearer of eyewear comprising such known lenses, views a target through the central distance region, the optical effects of the myopia-controlling region will be restricted to the peripheral retina. Therefore, where the myopia control stimulus is defocus, the myopia controlling region defocuses the peripheral image. Similarly, where the myopia control stimulus is contrast attenuation, the myopia controlling region reduces the contrast in the peripheral image.

A disadvantage of such eyewear can be that the blurring or contrast attenuation caused by the myopia controlling region reduces the clarity with which the target is perceived in the wearer's peripheral field, thereby reducing the ability of the wearer to discern the finer details of the target.

Where the eyewear comprises lenses that are spaced-apart from the wearer's eye, such as spectacles for example, the wearer may adjust their gaze angle such that they view targets directly through the myopia-controlling region. In this situation the myopia control stimulus will affect the central retinal image and the wearer will therefore perceive the viewed target as being blurred or having reduced contrast, for example.

The present invention seeks to provide improved eyewear, such as spectacles and contact lenses, that prevents or slows the progression of myopia. The present invention also seeks to provide lenses for use in the improved eyewear, as well as methods of manufacturing such lenses.

### SUMMARY

According to a first aspect, the present disclosure provides eyewear for slowing the progression of myopia, the eyewear comprising a left lens and a right lens, the left and right lens each including an optic zone comprising a central region providing a base power and centred on an optical axis, and an outer region disposed outwardly of, for example surrounding, the central region. The outer region comprises at least a first subregion that provides one of a first optical property or a second optical property at a first position with respect to the optical axis, and at least a second subregion that provides the other of the first optical property or the second optical property at a second position with respect to the optical axis. The first and second positions with respect to the optical axis of the left lens correspond with the respective first and second positions with respect to the optical axis of the right lens. The outer regions of the left lens and the right lens are complementarily arranged such that the first and second subregions of the left lens have different optical properties to the corresponding first and second subregions of the right lens. The first optical property is a myopia control stimulus and the second optical property is an optical power for providing distance vision when the eyewear is worn.

According to a second aspect, the present disclosure provides a pair of lenses suitable for use as the respective left and right lenses of the eyewear of the first aspect of the present disclosure.

According to a third aspect, the present disclosure provides a method of making a pair of lenses suitable for use as the respective left and right lenses of the eyewear of the first, fourth and fifth aspects of the present disclosure. The method comprises providing a first lens puck having an optic zone comprising a central region providing a base power and defining a central axis, and an outer region surrounding the central region. The outer region comprises at least a first subregion and a second subregion, wherein one of the first subregion or second subregion provides a myopia control stimulus. The method comprises removing material from the first lens puck to form a first lens from the first lens puck at a first angle with respect to the central axis of the first lens puck, the first lens being shaped such that an optical axis of the first lens coincides with the central axis of the lens puck. The method additionally comprises providing a second lens puck having an optic zone that is substantially identical to the optic zone of the first lens puck. The method comprises removing material from the second lens puck to form a second, complementary shaped lens from the second lens puck at a second angle with respect to the central axis of the second lens puck. The first angle and the second angle are chosen such that the first and second lenses are suitable for use as the respective first and second lenses of the eyewear of the first aspect of the present disclosure.

According to a fourth aspect, the present disclosure provides eyewear for slowing the progression of myopia, the eyewear comprising a left lens and a right lens pair, wherein at least one myopia control stimulator region of predefined size and position on the left lens corresponds in size and position to a respective at least one distance vision region in the right lens, and at least one myopia control stimulator region of predefined size and position on the right lens corresponds in size and position to a respective at least one distance vision region in the left lens.

According to a fifth aspect, the present disclosure provides eyewear for slowing the progression of myopia, the eyewear comprising a left lens and a right lens, the left and right lens including respective optic zones respectively comprising a respective central region centered on a respective optical axis and arranged to provide a respective base power when the eyewear is worn, and a respective outer region disposed outwardly of the respective central region. The outer region of the left lens comprises at least a first left lens subregion, having a first shape and size and disposed at a first position with respect to the lens optical axis, and arranged to provide a myopia control stimulus when the eyewear is worn; and a second left lens subregion having a second shape and size and disposed at a second position with respect to the lens optical axis, and arranged to provide distance vision when the eyewear is worn. The outer region of the right lens comprises at least a first right lens subregion, having a shape and size the same as or closely similar to the first shape and size of the first left lens subregion, and disposed at a position with respect to the right lens optical axis that is the same as or closely similar to the first position of the first left lens subregion with respect to the left lens optical axis, and arranged to provide distance vision when the eyewear is worn. A second right lens subregion having a shape and size the same as or closely similar to the second shape and size of the second left lens subregion, and disposed at a position with respect to the right lens optical axis that is the same as or closely similar to the second position of the second left lens subregion with respect to the left lens optical axis, and arranged to provide a myopia control stimulus when the eyewear is worn.

It will of course be appreciated that features described in relation to one aspect of the present disclosure may be incorporated into other aspects of the present disclosure. For example, the method of the disclosure may incorporate features described with reference to the apparatus of the disclosure and vice versa.

### DESCRIPTION OF THE DRAWINGS

Embodiments of the present disclosure will now be described by way of example only with reference to the accompanying schematic drawings of which:

FIG. 1 is a schematic drawing of a pair of spectacles in accordance with an embodiment of the present disclosure;

FIG. 2 is a schematic drawing of the optic zones of a pair of lenses according to a first embodiment of the present disclosure;

FIG. 3 is a schematic drawing of the optic zones of a pair of lenses according to a second embodiment of the present disclosure;

FIG. 4 is a schematic drawing of the optic zones of a pair of lenses according to a third embodiment of the present disclosure;

FIG. 5 is a schematic plot showing the proportion of focused light being imaged through the effective pupil at the spectacle lens plane in the left and right lenses (y-axis) as a function of lens radial position in the respective outer regions of the lenses of FIG. 4 (x-axis);

FIG. 6 is a schematic drawing of the optic zones of a pair of lenses according to a fourth embodiment of the present disclosure;

FIG. 7 is a schematic drawing of the optic zones of a pair of lenses according to a fifth embodiment of the present disclosure;

FIG. 8 is a schematic drawing illustrating how an outer region may be formed by a plurality of lenslets;

FIG. 9 is a schematic drawing of the optic zones of a pair of lenses according to a sixth embodiment of the present disclosure;

FIG. 10 shows a lens puck suitable for forming a lens in accordance with an embodiment of the present disclosure, wherein the lens puck is provided with a hexagonal array of lenslets suitable for forming an outer region;

FIG. 11 shows a superposition of a first set of hexagonally arranged lenslets and a second set of hexagonally arranged lenslets which have been rotated by an angle of 30 degrees with respect to one another;

FIG. 12 is a schematic drawing of the optic zones of a pair of lenses according to a seventh embodiment of the present disclosure;

FIG. 13 is a schematic drawing of the optic zones of a pair of lenses according to an eighth embodiment of the present disclosure;

FIG. 14A is a schematic drawing of a first spiral power map, which can be superposed with the spiral power map of FIG. 14B to provide the optic zone of the right lens of FIG. 13;

FIG. 14B is a schematic drawing of a second spiral power map, which can be superposed with the spiral power map of FIG. 14A to provide the optic zone of the right lens of FIG. 13;

FIG. 15 is a schematic drawing of a pair of contact lenses in accordance with an embodiment of the present disclosure; and

FIG. 16 is flowchart illustrating a method of manufacturing a pair of lenses suitable for use in eyewear in accordance with the present disclosure.

### DETAILED DESCRIPTION

According to a first aspect, the present disclosure provides eyewear for slowing the progression of myopia, the eyewear comprising a left lens and a right lens, the left and right lens each including an optic zone comprising a central region providing a base power and defining an optical axis, an outer region surrounding the central region. The outer region comprises at least a first subregion that provides one of a first optical property or a second optical property at a first position with respect to the optical axis, and at least a second subregion that provides the other one of the first optical property or the second optical property at a second position with respect to the optical axis. The first and second positions with respect to the optical axis of the left lens correspond to the respective first and second positions with respect to the optical axis of the right lens. The outer regions of the left lens and the right lens are complementarily arranged such that the first and second subregions of the left lens have different optical properties to the corresponding first and second subregions of the right lens. The first optical property is a myopia control stimulus and the second optical property is an optical power for providing distance vision when the eyewear is worn.

The term “eyewear” as used herein refers to apparatus comprising ophthalmic lenses in accordance with the present disclosure that, in use, are worn by a user (referred to herein as a “wearer” of the eyewear) to correct and slow the progression of myopia. Accordingly, the term “eyewear” encompasses spectacles (also known as eyeglasses) and contact lenses. The term “eyewear” also encompasses any other equipment that may incorporate myopia-correcting lenses, for example, sporting equipment (e.g. diving masks) or augmented reality headwear.

The optical axis of the lens is defined with reference to a distant point source of light. Light from a distant point source that is on the optical axis of the lens (which may hereafter be referred to as an on-axis distant point source) will be focussed to a point also on the optical axis of the lens.

The optical axis may lie along the centreline of the lens. For example, where the lens is a contact lens, the optical axis generally lies along the centreline of the lens. However, the optical axis may of course not lie along the centreline of the lens; this may be the case in a spectacle lens, where the position of the optical axis of the lens will be determined by the interpupillary distance of the wearer, which, depending on the lens geometry, may not coincide with the centreline of the lens.

The first and second positions with respect to the optical axis of the left lens correspond with the respective first and second positions with respect to the optical axis of the right lens. Arranged thus, the first subregion of the right lens (or “first right lens subregion”) may be disposed at a position with respect to the right lens optical axis that is the same as or closely similar to the position at which the first subregion of the left lens (or “first left lens subregion”) is disposed with respect to the left lens optical axis. Similarly, the second subregion of the right lens (or “second right lens subregion”) may be disposed at a position with respect to the right lens optical axis that is the same as or closely similar to the position at which the second subregion of the left lens (or “second left lens subregion”) is disposed with respect to the left lens optical axis.

The positions of the myopia controlling subregions and the subregions having no myopia control are complementarily arranged in each of the respective lenses i.e. such that where a subregion of either of the lenses provides a myopia-control stimulus at a given position with respect to the optical axis of the lens, the subregion at the same position with respect to the respective optical axis in the other of the lenses does not. Arranged thus, where a region of a given retina of a wearer is targeted by a subregion of its corresponding lens providing a myopia control stimulus, the corresponding region in the wearer's other retina will be targeted by a subregion of its corresponding lens that provides no myopia control stimulus. Therefore, where the wearer is viewing a target along the optical axis of the lens (such as is generally the case with contact lenses but not always the case with spectacles), corresponding peripheral regions of a wearer's left and right retinas will be targeted by complimentary subregions of their respective lenses. Where the eyewear comprises ophthalmic lenses that do not rotate with the eye, such as spectacles, when a wearer of the eyewear views a target through the outer zones of the respective left and right lenses, substantially all of the wearer's left and right retinas may be targeted by complementary subregions of their respective lens, with only one of said subregions providing the myopia control stimulus.

The visual fields of the eye can be divided into quadrants, and these quadrants can also be used to describe the quadrants of a lens when positioned on or in front of an eye. The upper half of the eye/lens is the superior half, and the lower half is the inferior half. The visual field that is closest to the nose is the nasal half, and the visual field that is furthest from the nose is the temporal half. Four quadrants can therefore be defined as superior-nasal, superior-temporal, inferior-nasal and inferior-temporal. These quadrants can be used to describe the location of the subregions of the left and right lenses. For example, considering the lens when positioned on the eye if the myopia controlling subregion of the left lens is confined with the inferior half of the lens, the myopia controlling subregion of the right lens may be confined within the superior half of the lens. Alternatively, if the myopia controlling subregion of the left lens is confined within the temporal half of the lens, the myopia controlling region of the right lens may be confined within the nasal half of the lens.

The central region may have a curvature that provides the base power. The centre of curvature may be centred on the optical axis of the lens. The central region may correct for distance vision. The base power may therefore be from −0.25 to −15.0 dioptres (D). In some embodiments the lenses may be configured for wearers that do not have myopia in order to provide myopia prophylaxis, in these embodiments the base power of at least one of the lenses may be from 0 D to +3.0 D. The second optical property may be an optical power equal to the base power. The second optical property may be an optical power suitable to provide distance vision when the eyewear is worn but which is different to the base power. The second optical property may be an optical power between 0 D and −15.0 D, for example.

The myopia control stimulus may comprise one or more of: defocus, contrast attenuation, and manipulation of the spectrum of visible light received by the retina. The first optical property may provide an optical power for providing distance vision when the eyewear is worn in addition to a myopia control stimulus. In some embodiments, the second optical property may provide a myopia control stimulus which is different to the myopia control stimulus of the first optical property (for example, one or more of contrast attenuation and manipulation of the spectrum of visible light received by the retina).

Where the myopia-controlling stimulus is defocus, the myopia-controlling subregions may provide an optical add-power so that the lens power within the subregion is greater (i.e., more positive than or less negative than) the base power of the central region. The optical add-power may create blur and reduce contrast at the retina. The add power provided may be from about +0.5 to +20 D, preferably from about +0.5 to +10.0 D more positive than the base power. The add power may focus incoming light that is parallel to the optical axis (i.e., light from a distance) to a point on the optical axis of the lens, wherein the point is in front of the retina when the lens is worn by a lens wearer. The add power may focus incoming light that is parallel to the optical axis (i.e., light from a distance) to a set of points that are situated at a first distance from the optical axis. For example, the light may form a focal ring in front of the retina when the lens is worn by a lens wearer.

In embodiments where the myopia-controlling stimulus is contrast attenuation, the myopia-controlling subregions may be configured to reduce contrast on the retina without defocus. In embodiments, the myopia-controlling subregions may comprise optical elements that are configured to scatter light in order to reduce contrast on the retina, relative to the retinal locations targeted by the central region of the lens.

In embodiments where the myopia-controlling stimulus involves manipulation of the spectrum of visible light received by the retina, the myopia-controlling subregions may remove portions of the visible light spectrum. For example, the myopia-controlling subregions may comprise one or more coloured filters. A suitable coloured filter may be a red filter or a violet filter, for example.

The central region may be substantially circular in shape and may have a diameter of between about 2 and 9 millimetres. In some embodiments the central region may have a diameter of between about 2 and 7 millimetres. The central region may be substantially elliptical in shape. In some embodiments, either or both of the first and second subregions may have a minimum dimension in a nominal plane of the lens which is the same or closely similar to the diameter of the central region.

The size of the subregions of the left lens may be the same or closely similar in size to the corresponding subregions in the right lens. For example, the first subregion of the left lens may be the same or closely similar in size to the first subregion of the right lens. The second subregion of the left lens may be the same or closely similar in size to the second subregion of the right lens. Alternatively or additionally, the shape of the subregions of the left lens may be the same or closely similar in shape to the corresponding subregions in the right lens. For example, the first subregion of the left lens may be the same or closely similar in shape to the first subregion of the right lens. The second subregion of the left lens may be the same or closely similar in shape to the second subregion of the right lens.

The first and second subregions may be arranged concentrically with respect to the central region. The first and second subregions may be generally annular in shape. The first region may be contiguous with the central region. The first subregion may fully or partially surround the central region. The first subregion may be interposed between the second subregion and the central region. The first subregion may fully or partially surround the second subregion. The first subregion may be contiguous with the second subregion. The second subregion may be contiguous with the central region. The second subregion may fully or partially surround the central subregion. The second subregion may be interposed between the first subregion and the central region. The term generally annular is intended to encompass the form of a circular annulus or of annuluses having other shapes. For example, the subregions may be generally oval annuluses or annuluses having a general polygonal shape.

The first and second subregions may be arranged circumferentially around the central region. The optic zone may comprise an outer edge. The first subregion may extend from the central region to an outer edge of the optic zone. The second subregion may extend from the central region to an outer edge of the optic zone. Where the first and second regions are arranged circumferentially around the central region, the first and second regions may take on a variety of shapes and forms. For example, the optic zone could simply be divided into two, with one half corresponding to the first subregion and the other half corresponding to the second subregion. In some embodiments, the first subregion and, alternatively or additionally, the second subregion may be formed by a polygonal shape, such as a trapezoid, for example. In some embodiments the first subregion and, alternatively or additionally, the second subregion may be formed by a circular shape or some other generally curved shape.

The optic zone of each of the left lens and the right lens may be configured such that the first subregion forms part of a first plurality of subregions within the outer region, each subregion of the first plurality providing the one of the first optical property or the second optical property at a first plurality of positions with respect to the optical axis. The optic zone of each of the left lens and the right lens may be configured such that the second subregion forms part of a second plurality of subregions within the outer region, each subregion of the second plurality providing the other one of the first optical property or the second optical property at a second plurality of positions with respect to the optical axis. The first and second pluralities of positions with respect to the optical axis of the left lens may correspond with the respective first and second pluralities of positions with respect to the optical axis of the right lens. The first and second pluralities of subregions of the left lens may have different optical properties to the corresponding first and second pluralities of subregions of the right lens.

The positions of the myopia controlling subregions and the subregions having no myopia control may therefore be complementarily arranged in each of the respective lenses.

The first and second subregions may be arranged concentrically with respect to the central region. One or more of the subregions of the first plurality may be interposed between subregions of the second plurality, or vice versa. Each subregion of the first plurality of subregions may be generally annular. Each subregion of the second plurality of subregions may be generally annular. Each subregion of the first plurality of subregions may be arranged concentrically with respect to the central region. Each subregion of the second plurality of subregions may be arranged concentrically with respect to the central region. Each subregion of the first plurality may be generally annular. Each subregion of the second plurality may be generally annular. The first and second subregions may be arranged circumferentially around the central region. The subregions of the first plurality of subregions may be circumferentially spaced around the central region. Alternatively or additionally, the subregions of the first plurality of subregions may be radially spaced with respect to the central region. The subregions of the second plurality of subregions may be circumferentially spaced around the central region. Alternatively or additionally, the subregions of the second plurality of subregions may be radially spaced with respect to the central region. The subregions of the first plurality of subregions and the second plurality of subregions may be circumferentially interposed around the central region. The subregions of the first plurality of subregions and the second plurality of subregions may be radially interposed with respect to the central region.

Each subregion of either the first plurality of subregions or the second plurality of subregions may be formed by a lenslet. The left lens may therefore comprise a primary lens and one or more lenslets. Similarly, the right lens may comprise a primary lens and one or more lenslets. A lenslet may be a lens, or lens-like element, which is small relative to the primary lens. The lenslets may provide the myopia control stimulus. Each lenslet may therefore be configured to provide one or more of defocus, contrast attenuation, and manipulation of the spectrum of visible light. Where a lens comprises a plurality of subregions providing a myopia control stimulus, the subregions of that plurality may provide different types of myopia control stimulus.

Where the first plurality of subregions of one of the lenses comprises lenslets providing a myopia control stimulus, the second plurality of subregions of the other lens may comprise lenslets providing the myopia control stimulus and vice versa. The lenslets may be embedded within the primary lens. Alternatively or additionally, the lenslets may be arranged upon a front or rear surface the primary lens. In embodiments where the lenslets are arranged upon a surface of the primary lens, the lenslets may be provided by a film or a surface treatment. The lenslets may comprise a gradient-index film, also known as a GRIN film.

In embodiments, the lenslets may be an order of magnitude smaller than the primary lens. However, the lenslets will generally have a diameter of between 0.2 and 10 millimetres. Where the left and right lenses are configured to be spaced apart from a wearer's eyes, the lenslets may have a diameter of between 1 and 5 millimetres. In some embodiments, the lenslets may have a diameter of approximately 3 millimetres. Preferably neighbouring lenslets are spaced apart by a distance approximately equal to the lenslet diameter. Where the lenses are contact lenses, the lenslets may have a diameter of less than 1 millimetre.

Each lens may comprise a primary lens and an optic zone comprising a region of the primary lens and a plurality of lenslets distributed across the region of the primary lens. The region of the primary lens forming the optic zone may have a base power. In this case, subregions of the optic zone not providing the myopia control stimulus (i.e. those not comprising a lenslet) may be provided by portions of the optic zone between the lenslets. For example, the optic zone of each lens may have an outer region comprising a regularly spaced array of lenslets. The lenslets may, for example, be arranged in a hexagonal array. The lenslets may be arranged in a rosette structure. The rosette structure may be symmetrical or asymmetrical. In some embodiments this may permit lenses for the eyewear according to the present disclosure to be cut from a single design of lens puck, as described below.

Where the myopia control stimulus comprises defocus, the optic zone of each of the left lens and the right lens may be configured such that the outer region corresponds to a region of the lens where a first surface of the lens varies across the lens to form a first surface power map. The first surface power map may comprise a spiral with an add power that varies substantially periodically both radially outwards from and angularly about an optical axis of the lens. The add power may focus incoming light that is parallel to the optical axis (i.e., light from a distance) to a point on the optical axis of the lens, wherein the point is in front of the retina when the lens is worn by a lens wearer. The add power may focus incoming light that is parallel to the optical axis (i.e., light from a distance) to a set of points that are situated at a first distance from the optical axis. The outer region may correspond to a region of the lens where a second surface of the lens varies across the lens to form a second surface power map. The second surface power map may comprise a spiral, with an add power that varies substantially periodically radially outwards from and angularly about the optical axis of the lens. The spirals provided by the first and second surface power maps may twist in opposing directions.

The eyewear may be configured such that, in use, the left and right lenses are spaced-apart from a wearer's eyes. The eyewear may, for example, be a pair of spectacles. In some embodiments the lenses of the eyewear may be round (i.e. the lenses may have 360 degrees of rotational symmetry). In other embodiments, the lenses may be non-round. It is possible that in some embodiments of eyewear where the lenses are spaced-apart from the wearer's eyes, the centreline of each lens coincides with the optical axis of the lens, for example where the lenses are round. However, in such eyewear the optical axes of the lenses may not coincide with the centrelines of the lenses.

Where the eyewear is configured such that the left and right lenses are spaced apart from a wearer's eyes, the first subregion and, alternatively or additionally, the second subregion may have a minimum dimension in a nominal plane of the lens of between 1 and 10 millimetres. The first subregion may have a minimum dimension in a nominal plane of the lens of at least 3 millimetres. The second subregion may have a minimum dimension in a nominal plane of the lens of at least 3 millimetres. As discussed in more detail below, where the left and right lenses are spaced-apart from a wearer's eyes, it is advantageous for the subregions to have a size at least equal, and preferably greater than, an entrance pupil size on the lens corresponding to a wearer of the eyewear gazing through the lens. A minimum dimension of at least 3 millimetres ensures that the subregions are at least of an approximate size to the entrance pupil size on the lens. However, the minimum dimension is preferably greater than 3 millimetres.

The eyewear may comprise a pair of contact lenses. Where a lens is a contact lens, the first subregion may have a minimum dimension in a nominal plane of the lens of at least 1 millimetre. The second subregion may have a minimum dimension in a nominal plane of the lens of at least 1 millimetre.

Either or both of the first and second subregions may extend in a radially outwards direction by between about 0.1 to 4 mm. For example, the radial width of either or both of the first and second subregions may be about 0.1 mm to about 4 mm. In some embodiments, the first and second subregions may extend in a radially outwards direction by between about 0.5 mm and 1.5 mm. For example, the radial width of either or both of the first and second subregions may be about 0.5 mm to about 1.5 mm in such embodiments.

The perimeter of the central region may define a boundary between the central region and either or both of the first and second subregions, and either or both of the first and second subregions may therefore be adjacent to the central region. The perimeter of the central region may define a boundary between the central region and only one of the first and second subregions, in which case the one of the first and second subregions may therefore be adjacent to the central region.

Where the left and right lenses are contact lenses, the contact lenses may comprise a rotational stabilizer. The rotational stabilizer may ensure that the contact lenses are prevented from rotating substantially within the wearer's eye in use. The left and right contact lenses may each comprise a rotational stabilizer configured to maintain the correspondence relative to the eyes of a wearer between the first and second positions of the left lens and the respective first and second positions of the right lens. The position relative to the optical axis of the contact lens of each of the rotational stabilizers may be substantially the same in the first contact lens and in the second contact lens in order to ensure that the respective subregions of the lenses remain complementarily arranged in use. The skilled person will be aware of various types of rotational stabilizer. As an example, the rotational stabilizers may comprise a ballast to orient the lens when positioned on the eye of a wearer. Embodiments of the disclosure incorporating a ballast into the contact lens will, when placed on the eye of a wearer, rotate under the action of the wearer's eyelid to a pre-determined angle of repose; for example, the ballast may be a wedge and the rotation may result from the action of the eyelid on the wedge. It is well-known in the art to ballast a contact lens to orient a contact lens; for example, toric contact lenses are ballasted to orient the lens so that the orthogonal cylindrical corrections provided by the lens align correctly for the astigmatism of the wearer's eye.

According to a second aspect, the present disclosure provides a pair of lenses suitable for use as the respective left and right lenses of the eyewear of the first aspect of the present disclosure. The lenses may be suitable for use in eyewear that is configured such that the left and right lenses are spaced apart from a wearer's eyes. The lenses may comprise any of the features described herein with respect to the left and right lenses of the eyewear according to the first aspect of the disclosure.

According to a third aspect, the present disclosure provides a method of making a pair of lenses for eyewear. The method comprises providing a first lens puck having an optic zone comprising a central region providing a base power and defining a central axis, an outer region surrounding the central region, the outer region comprising at least a first subregion and a second subregion, wherein one of the first subregion or second subregion provides a myopia control stimulus. The method comprises removing material from the first lens puck to form a first lens from the first lens puck at a first angle with respect to the central axis of the first lens puck, the first lens being shaped such that an optical axis of the first lens coincides with the central axis of the lens puck. The method comprises providing a second lens puck having an optic zone that is substantially identical to the optic zone of the first lens puck, removing material from the second lens puck to form a second, complementarily shaped lens from the second lens puck at a second angle with respect to the central axis of the second lens puck. The first angle and the second angle are chosen such that the first and second lenses are suitable for use as the respective left and right lenses of the eyewear of the first aspect of the present disclosure.

The first angle may be angularly spaced from the second angle by an angle of 180 degrees or less. The lenses may be round or non-round. Where the lenses are round, the centrelines of the lenses will not coincide with the optical axes of the lenses. The optic zones of the first and second lens pucks may have any of the features described herein with respect to the optic zones of the left and right lenses of the eyewear according to the first aspect of the disclosure. For example, the optic zone of each lens puck may be configured such that it has an outer zone comprising a first plurality of subregions and a second plurality of subregions, wherein the subregions of the first plurality and the subregions of the second plurality are circumferentially interposed around the central region, and wherein only the subregions of the first plurality or second plurality provide a myopia control stimulus.

Although human vision is dominated by a singular perception of the world, that singular perception is formed by two separate images: one from the right eye and one from the left eye. When light is imaged onto corresponding points of the respective left and right retinas, neural connections converge the signals provided by the retinas to form a single percept. However, when corresponding points on the left and right retinas receive noticeably different images the brain does not necessarily convert those signals into a single percept. For example, where the left and right retinas are receiving completely different images, bistable perception, also known as binocular rivalry, may occur. In this situation, the percept will alternate between the image received by the left retina and the image received by the right retina.

However, where the left and right retinas receive different images, but one of those images alone, or a composite of the two images can be formed to show a consistent scene, the binocular percept will be of that of a singular and consistent scene. For example, it has been demonstrated that bistable vision does not occur when one eye sees a focussed image and the other eye sees a significantly defocussed (blurred) image (Arnold, D. H., Grove, P. M., & Wallis, T. S. (2007); Staying focused: A functional account of perceptual suppression during binocular rivalry. Journal of Vision, 7 (7), 7-7; Arnold, D. H. (2011); Why is binocular rivalry uncommon? Discrepant monocular images in the real world. Frontiers in Human Neuroscience, 5, 116). Instead, the brain suppresses the blurred image and the binocular percept is that of the focussed image, even where images are chosen that will generate binocular rivalry if both are focussed.

Another example of the perceptual dominance of a monocular focussed image over a monocular blurred images is given in Schor et al (Schor, C., Landsman, L., & Erickson, P. (1987). Ocular dominance and the interocular suppression of blur in monovision. American journal of optometry and physiological optics, 64 (10), 723-730). In that study, it was shown that when the left and right eyes are presented with separate left and right images, where each image consists of an array of the same letters in the same order but where the left and right versions of the array contain a complementary mixture of focussed and blurred letters, the binocular precept is only of the focussed letters. This phenomenon highlights an ability of the visual system to suppress a blurred image from one eye at one location in favour of a focussed image from the corresponding position in the other eye. The human visual system is therefore able to effectively stitch together a full focussed image from a pair of images comprising complementarily arranged focussed and blurred regions. A similar effect has been demonstrated in relation to contrast; where one eye is subjected to a high contrast image and the eye is subjected other low contrast image, then it is the eye subjected to the high contrast image that dominates perception (Qiu, S. X., Caldwell, C. L., You, J. Y., Mendola, J. D. (2020). Binocular rivalry from luminance and contrast. Vision Research, 175, 41-50).

The lenses of the eyewear of the present disclosure have been designed to take advantage of perceptual dominance of the type described above to provide myopia controlling vision correction whereby negative effects resulting from myopia controlling optical elements in an outer region of a lens are mitigated.

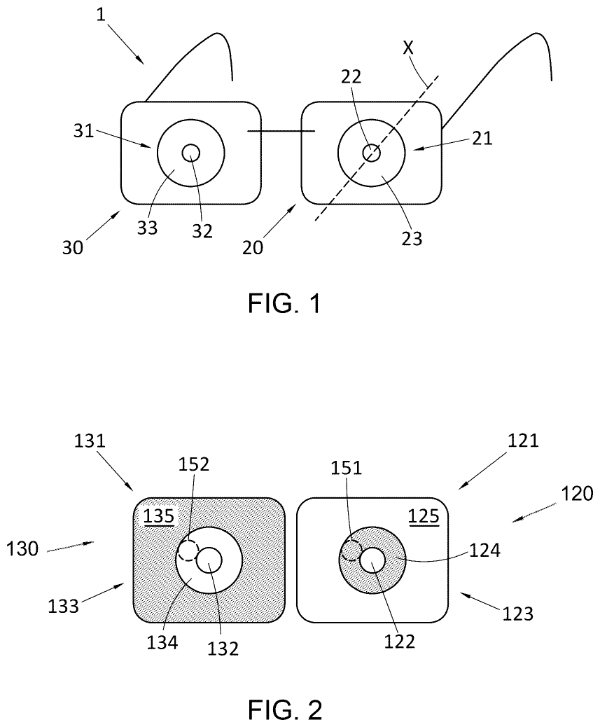

FIG. 1 shows an example of eyewear 1 according to the present disclosure comprising a pair of respective left and right lenses 20, 30 configured for use in slowing progression of myopia. In the example shown in FIG. 1, the eyewear 1 is a pair of spectacles, or eyeglasses. However, it will be appreciated by those of ordinary skill in the art that other types of myopia-controlling eyewear comprising the lenses described herein will fall within the scope of the present disclosure.

Each lens comprises an optic zone 21, 31 having myopia-correcting central region 22, 32 and an outer region 23, 33 surrounding the central region 22, 32. The central regions 22, 32 have a curvature providing a base power centred on a centre of curvature that is on an optical axis of the respective lens 20, 30. The optical axis X of the left lens 20 is shown schematically in FIG. 1 for the purpose of illustration. The optical axis X in this case lies along the centreline of the lens 20. However, it will be appreciated that in embodiments of the disclosure, for example particularly in spectacle lenses, the optical axis may not coincide with the lens centreline. While the central regions 22, 32 of the example embodiment shown in FIG. 1 are circular and the outer regions 23, 33 are annular, it will of course be appreciated that in other embodiments those regions may be formed by other shapes.

The central region 22, 32 of each lens 20, 30 provides a lens power corresponding to distance vision and will generally have a size at least as large as the entrance pupil in a nominal plane defined by the lens for light entering the eye of the wearer.

The minimum size of the central region 22, 32 may therefore be dependent on the size of the entrance pupil of the wearer's eyes, which will depend on age, and on the distance by which the lenses 20, 30 are spaced apart from the wearer's eyes. In embodiments where the lens is a spectacle lens, the diameter of the central region may be between 3 and 10 millimetres. However, in other embodiments, the diameter of the central region may fall outside of this range. Generally, the diameter of the central region will be between 1 and 25 millimetres.

The outer region 23, 33 of each lens 20, 30 comprises myopia-controlling subregions and myopia-correcting subregions. It should be noted that while subregions of the lenses described herein are referred to as “myopia-correcting subregions”, it is within the scope of the present disclosure for the eyewear to be provided as a myopia prophylaxis; in such embodiments the “myopia-correcting subregions” and the central region may not provide any substantial myopia correction. In such embodiments, the base power of the lenses and optical power of the “myopia-correcting subregions” may, for example, be from 0 D to +3.0 D. However, it is envisaged that in the vast majority of applications, the “myopia-correcting subregions” and the central region will have an optical power providing at least some myopia correction.

In embodiments of the disclosure, the myopia-controlling subregions may provide various myopia-controlling stimuli. Where the myopia-controlling stimulus is defocus, for example, the myopia-controlling subregions may provide an optical add-power, which creates blur and reduces contrast at the retina. The add power may focus incoming light that is parallel to the optical axis (i.e., light from a distance) to a point on the optical axis of the lens, wherein the point is in front of the retina when the lens is worn by a lens wearer. The add power may focus incoming light that is parallel to the optical axis (i.e., light from a distance) to a set of points that are situated at a first distance from the optical axis. For example, the light may form a focal ring in front of the retina when the lens is worn by a lens wearer. In embodiments where the myopia-controlling stimulus is contrast attenuation, the myopia-controlling subregions may be configured to reduce contrast on the retina without defocus. For example, the myopia-controlling subregions may comprise optical elements that are configured to scatter light in order to reduce contrast on the retina. In some embodiments, the myopia-controlling stimulus may alternatively or additionally involve manipulation of the spectrum of visible light received by the retina. For example, the myopia-controlling subregions may comprise one or more coloured filters that filter out particular parts of the visible light spectrum. A red filter or a violet filter may for example be used in a myopia-controlling subregion.

As will become apparent from the example embodiments described below with reference to FIG. 2 to FIG. 14B, the myopia controlling subregions and the myopia correcting subregions can have various shapes and sizes. However, a feature common to all of the example embodiments described below is that the positions of the myopia controlling subregions and the myopia correcting subregions are complementarily arranged in each of the respective lenses of the lens pair in order to take advantage of the perceptual dominance of subregions providing no myopia control stimulus over subregions providing a myopia control stimulus. Arranged thus, for the vast majority of locations on the left and right retinas, where light received by one of the retinas has passed through a myopia controlling subregion of one lens, at the corresponding position on the other retina the received light will have passed through a myopia correcting subregion of the other lens. For example, where the myopia control stimulus is defocus, the left and right retinas will each receive a complementary mixture of focussed and blurred regions of the target that the wearer of the eyewear is viewing so that the brain discards the blurred regions and the binocular percept will be only of the focussed target.

Example embodiments of various lenses having outer regions configured as described above and, as such, are suitable for use in eyewear according to the present disclosure will now be described.

In the first example lens pair embodiment, the outer region 123 of the left lens 120 is partitioned into a single annular myopia-controlling subregion 124, which surrounds and is contiguous with the central region 122. A single myopia correcting subregion 125 surrounds and is contiguous with the annular myopia-controlling subregion 124. The outer region 133 of the right lens 130 is partitioned into subregions 134, 135 in substantially the same way as the left lens but the optical properties of those subregions have been swapped with respect to the corresponding regions 124, 125 in the left lens. As such, the outer region 133 of the right lens has an annular myopia-correcting subregion 134 and a single myopia-controlling subregion 135 that surrounds and is contiguous with the annular myopia-correcting subregion 134. With the outer regions 123, 133 of the respective lenses configured in this way, corresponding regions of the wearer's retina will receive light that has passed through the complementary regions of the lenses. For example, as illustrated in schematically in FIG. 2, when the wearer is looking up and to the left, the entrance pupils 151, 152 target the respective left and right retinas. As can be seen, the left retina is targeted by the myopia-controlling subregion 124 of the outer region 123 of the left lens and the right retina is targeted by a complementary myopia-correcting subregion 134 of the outer region 133 of the right lens.

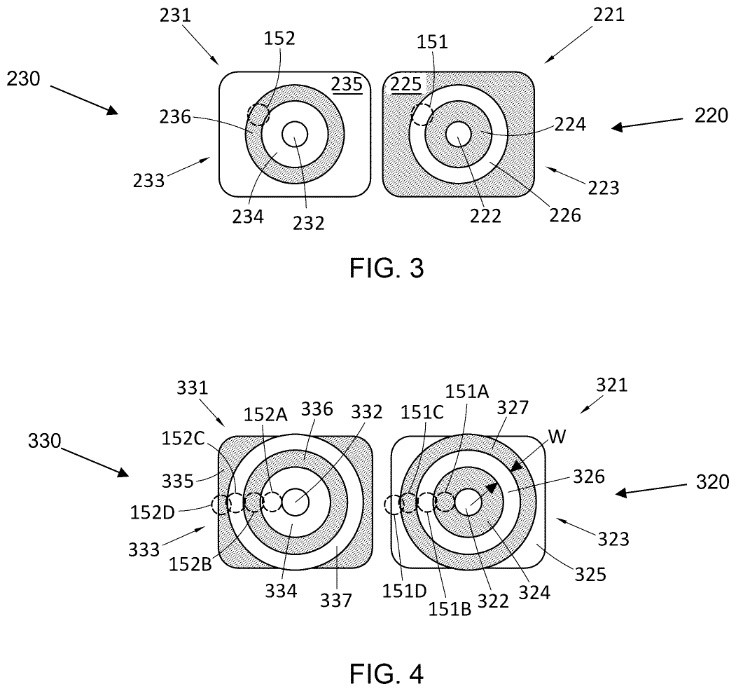

The second example lens pair embodiment, which is shown in FIG. 3, has a left lens 220 having an optic zone 221 formed by a myopia-correcting central region 222 surrounded by an outer region 223 and a right lens 230 having an optic zone 231 formed by a myopia-correcting central region 232 surrounded by an outer region 233. The outer regions 223, 233 of the respective left and right lenses 220, 230 are partitioned in a similar way to those of the first lens pair embodiment.

However, each of the outer regions 223, 233 comprises a second annular subregion 226, 236, which surrounds and is contiguous with the first annular subregion 224, 234. As such, the left lens 220 comprises an annular myopia-controlling subregion 224, an annular myopia-correcting subregion 226, which surrounds the annular myopia-controlling subregion 224, and an outer myopia-controlling subregion 225 that surrounds and is contiguous with the annular myopia-correcting subregion 226. The right lens 230 comprises an annular myopia-correcting subregion 234, an annular myopia-controlling subregion 236, which surrounds the annular myopia-correcting subregion 234, and an outer myopia-correcting subregion 235 that surrounds and is contiguous with the annular myopia-controlling subregion 236.

The third example lens pair embodiment, which is shown in FIG. 4, has a left lens 320 having an optic zone 321 formed by a myopia-correcting central region 322 surrounded by an outer region 323 and a right lens 330 having an optic zone 331 formed by a myopia-correcting central region 332 surrounded by an outer region 333. The outer regions 323, 333 of the respective left and right lenses are partitioned in a similar way to those of the second lens pair embodiment shown in FIG. 3. However, each of the outer regions 323, 333 comprises a third annular subregion 327, 337, which surrounds and is contiguous with the second annular subregion 326, 336. As such, the left lens comprises an annular myopia-controlling subregion 324, an annular myopia-correcting subregion 326, which surrounds the annular myopia-controlling subregion 324, a further annular myopia-controlling subregion 327 that surrounds and is contiguous with the annular myopia-correcting subregion 326, and an outer myopia-correcting subregion 325. The right lens comprises an annular myopia-correcting subregion 334, an annular myopia-controlling subregion 336, which surrounds the annular myopia-correcting subregion 334, a further annular myopia-correcting subregion 337 that surrounds and is contiguous with the annular myopia-controlling subregion 336, and an outer myopia-correcting subregion 335.

It is within the scope of the present disclosure for other lens embodiments to comprise outer regions having any number of concentrically arranged subregions. Furthermore, while the embodiments described above comprise subregions formed by circular annuluses, in other embodiments subregions may, for example, be formed by annuluses defined by other curved or non-curved shapes, such as ellipses and polygons.

When viewing a target through the central region, the myopia control stimuli in the surrounding outer region are involved in generating images in the peripheral retina. However, in embodiments where the eyewear comprises lenses which are spaced apart from the eye, such as the spectacles shown in FIG. 1, the wearer's gaze angle may move to an orientation in which the fovea of the retina, which is responsible for central vision, will receive light that has passed through the outer region of the lens. In embodiments of the present disclosure, the respective myopia-controlling subregions and myopia-correcting subregions may be dimensioned with this situation in mind. For example, the minimum dimensions of the myopia-controlling subregions and, alternatively or additionally, the myopia-correcting subregions, in a nominal plane defined by the lens, may be at least as large as the entrance pupil on the lens through which light enters the wearer's eye. This sizing is advantageous because it can ensure that at least one retinal image will always have 100% (or at least a significant majority) of focussed light at all retinal locations when viewing a target through the outer region. In the case of spectacles, the effective entrance pupil size at the lens can be approximated by the eye's entrance pupil size. However, it will of course be understood that the effective pupil size at the spectacle lens plane will depend on the distance by which the lenses are spaced apart from the face, so the approximation to pupil size may not be appropriate in all applications. Eye entrance pupils are often in the 4 to 6 millimetre range but can be smaller in relatively high light environments and larger in relatively low light environments.

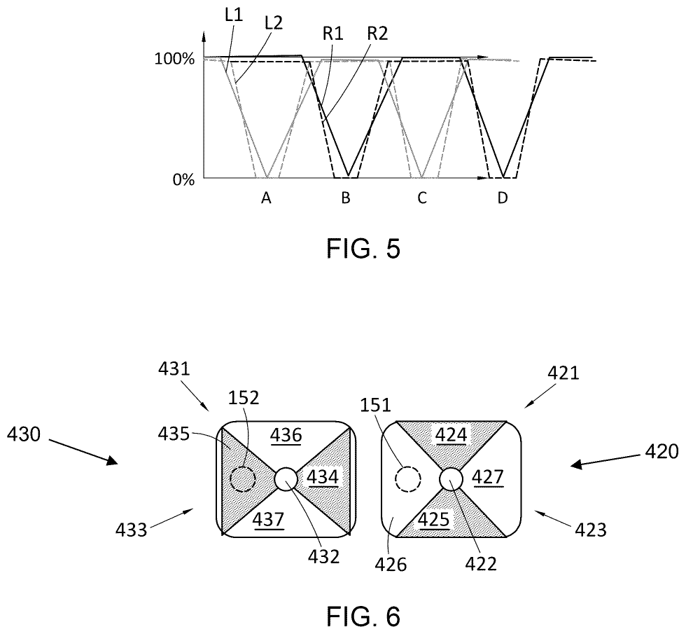

FIG. 5 shows schematic plots of the proportion of focused light being imaged through the effective pupil at the spectacle lens plane in the left (L1, L2) and right (R1, R2) lenses on the y-axis as a function of lens radial position in the respective outer regions 323, 333 of the lenses of FIG. 4. Plots L1 and L2 illustrate the percentage of focussed light received by the left retina due to light being imaged by the left lens as the gaze angle of the left eye moves from the central region 322 to region 151A, and then through to region 151D in the left lens shown in FIG. 4. Similarly plots R1 and R2 illustrate the percentage of focussed light received by the right retina due to light being imaged by the right lens as the gaze angle of the right eye moves from the central region 332 to region 152A, and then through to region 152D in the right lens (the points marked A, B, C, and D on the x-axis correspond to the regions 151A-151D and 152A-152D shown in FIG. 4, respectively). Plots L1 and R1 show the expected result if the width W of each of the annular subregions within the outer zones 323, 333 is equal to the entrance pupil diameter of the eye (i.e. the diameter of the circles 151A-D and 152A-D shown in FIG. 4). Plots L2 and R2 show the case if the optic zone width W is slightly greater than the entrance pupil diameter of the eye. FIG. 5 illustrates that it is preferable for the width W of the subregions within the outer region to be similar in size to, or larger than the diameter of the entrance pupil of the eye because one of the left and right retinal images will always have at least close to 100% focussed light at all retinal locations when the gaze angle corresponds to a position within the respective outer regions 323, 333. In embodiments, including those described below, the subregions of the outer region may therefore have a minimum dimension equal to or larger than the entrance pupil of a typical eye. For example, some embodiments may comprise subregions having a minimum dimension of 3 millimetres. In principle, there is no maximum dimension for a subregion, so that dimension may be determined by the size of the outer region.

In some embodiments, the outer region may comprise circumferentially arranged contiguous subregions. For example, the fourth lens pair embodiment shown in FIG. 6, has a left lens 420 having an optic zone 421 formed by a myopia-correcting central region 422 surrounded by an outer region 423, and a right lens 430 having an optic zone 431 formed by a myopia-correcting central region 432 surrounded by an outer region 433, wherein the outer region 423, 433 of each lens 420, 430 comprises four circumferentially arranged trapezoidal subregions. The outer region 423 of the left lens 420 comprises two myopia-controlling subregions 424, 425, arranged on opposing upper and lower (or superior and inferior) sides of the myopia-correcting central distance region 422. The left lens 420 also comprises two myopia-correcting subregions 426, 427, arranged on opposing lateral sides (the nasal and temporal sides) of the central myopia-correcting region 422. The outer region 433 of the right lens 430 is partitioned in a similar way to the outer region 423 of the left lens 420, with the myopia-controlling subregions 434, 435 interspersed between the myopia-correcting subregions 436, 437. However, the optical properties of the subregions of the outer region 433 of the right lens 430 have been rotated 90 degrees about the optical axis of the lens, relative to the outer region 423 of the left lens 420. Accordingly, the outer region 433 of the right lens 430 comprises two myopia-correcting subregions 436, 437 arranged on opposing upper and lower sides of the central myopia-correcting region 432. The right lens 430 also comprises two myopia-controlling subregions 434, 435, arranged on opposing lateral sides of the myopia-correcting central region 432.

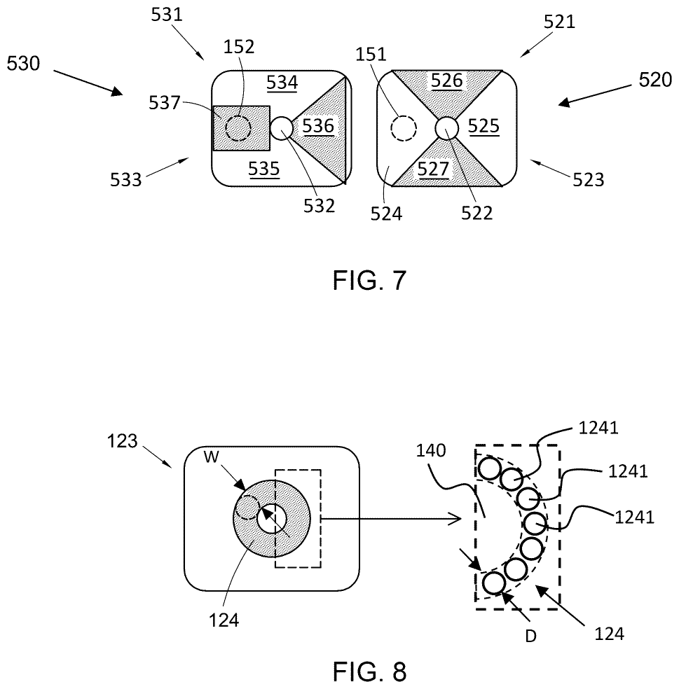

In embodiments of the disclosure, at least some of the subregions within the outer region may have different sizes and shapes. For example, in a fifth example embodiment shown in FIG. 7, the outer region 533 of the optic zone 531 of the right lens 530 comprises a substantially square myopia-controlling subregion 537 arranged on one lateral side (the temporal side) of the myopia-correcting central region 532 and a trapezoidal myopia-controlling subregion 536 arranged on the opposing lateral side (the nasal side) of the central region 532. The remainder of the outer region 533 is formed by myopia-correcting subregions 534, 535 arranged on opposing upper and lower sides (or superior and inferior sides) of the myopia-correcting central region 532. However, the outer region 523 of the optic zone 521 of the left lens 520 comprises trapezoidal myopia-correcting subregions 524, 525 arranged on opposing lateral sides (the nasal and temporal sides) of the central myopia-correcting region 522. The left lens 520 also comprises trapezoidal myopia-controlling subregions 526, 527 arranged on opposing upper and lower (or superior and inferior) sides of the myopia-correcting central distance region 522.

The myopia controlling subregions and the myopia-correcting subregions can be provided on the lens front surface or on the lens back surface. In some embodiments, one or both of the types of subregion may be provided by an additive combination of power induced from the front and back surfaces of the lens design. Alternatively or additionally, in some embodiments the subregions may be provided by optical components placed on a surface of a lens, or within the lens volume. The optical components may be lenslets, for example. FIG. 8 shows the outer region 123 of the left lens of the first embodiment shown in FIG. 2, but where the annular myopia-controlling subregion 124 is formed by a single ring of lenslets 1241 on a primary lens 140, such that the width W of the myopia-controlling subregion 124 is equal to the diameter D of the lenslets.

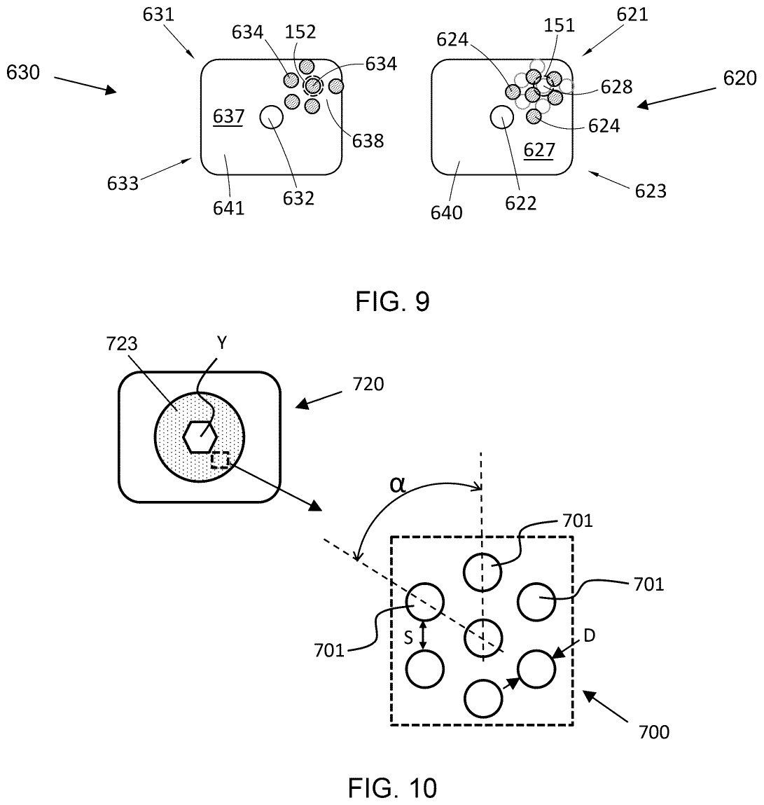

A sixth example lens pair embodiment, which is shown in FIG. 9, has a left lens 620 having an optic zone 621 formed by a myopia-correcting central region 622 surrounded by an outer region 623 and a right lens 630 having an optic zone 631 formed by a myopia-correcting central region 632 surrounded by an outer region 633. The outer regions 623, 633 comprise a single continuous myopia correcting region 627,637, provided by a primary lens 640, 641, in which the myopia-controlling lenslets 624, 634 are dispersed. As illustrated, the positions at which lenslets 624 are placed in the left outer region 623 correspond to positions at which no lenslets 634 are present in the right outer region 633. Similarly, the positions at which lenslets 634 are placed in the right outer region 633 correspond to positions at which no lenslets 624 are present in the left outer region 623.

As can be seen in FIG. 9, when the wearer is looking up and to the right, the entrance pupils 151, 152 target the respective left and right retinas. The left retina is targeted by a region 151 in the continuous myopia-correcting region 627 of the left outer region 623, and the right retina is targeted by a corresponding region 152 in the right outer region 633 containing a lenslet 634. Conversely, when the wearer's eyes are oriented such that a region containing a lenslet 624 targets the left retina, a subregion within the continuous myopia-correcting region 637 of the right lens will target the right retina. Configured as such, the lenslets 624, 634 form myopia controlling subregions, and the spaces between the lenslets within the continuous myopia-correcting region 627, 637 effectively form myopia-correcting subregions 628, 638 which are closely similar in size and shape to the lenslets.

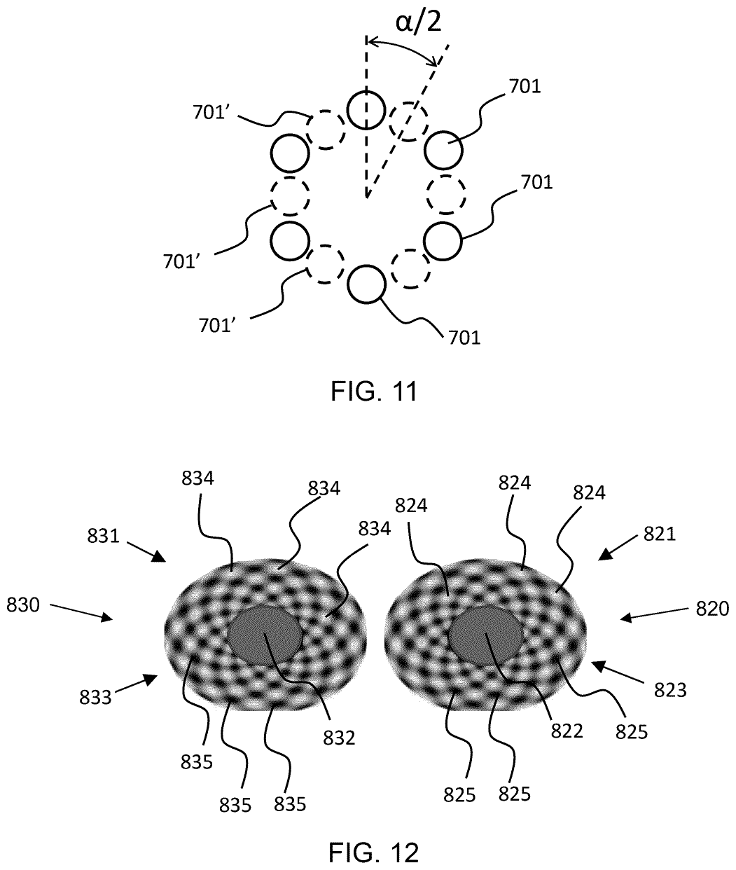

An outer region arrangement of the type shown in FIG. 9 could be achieved by designing separate left and right lens-specific outer regions. Alternatively, in some embodiments the lenslets may be regularly spaced in such a way that permits both left and right outer regions to be provided by the same array pattern of lenslets but where the patterns in the left and right lenses are angularly spaced-apart with respect to one another about the optical axes of the lenses. In arrangements such as this, or other arrangements where the myopia-controlling and myopia-correcting subregions are regularly arranged or interposed around the optical axis of the lens, such as that described above with reference to FIG. 6 and that described below with reference to FIG. 12, both left and right lenses can be cut from a single design of lens puck using the method illustrated in FIG. 16. For example, where the myopia control stimulus is provided by lenslets, lenslets 701 can be arranged on a lens puck 720 in a hexagonal lattice 700 within a region 723, as shown in FIG. 10. Arranged as such, the angle α between the optical centre of each lenslet is 60 degrees. FIG. 11 shows a superposition of a first array of lenslets 701 and a second array of lenslets 701′ that have been rotated with respect to one another to provide an angular spacing of a/2=30 degrees between the lenslet arrays 701, 701′. The diameter D of the lenslets is approximately equal to the spacing S between the lenslets so that, after a 30 degrees rotation, the lenslets 701′ of the second set are positioned between the lenslets of the first set 701. Therefore, a method of providing a pair of lenses according an embodiment of the present disclosure may comprise cutting a first lens from a lens puck 720 at a given orientation in a first step 5001. In a second step 5002, a corresponding second lens can be cut from a substantially identical lens puck 720 rotated about an axis Y of the lens puck 720 by an angle of 30 degrees relative to the orientation of the first lens (the axis Y extends out of the page in FIG. 10, perpendicularly to a nominal plane defined by the lens puck 720). The resulting first and second lenses will have complementarily arranged subregions comprising lenslets and subregions comprising no lenslets and will thereby be suitable for use in eyewear according to the present disclosure.

It will be appreciated that in embodiments, other outer region arrangements may permit left and right lens pairs to be created in accordance with the present disclosure by providing a first lens with the outer region at a first orientation and by providing a second lens with the same design of outer region oriented at a finite angle to the orientation of the outer region of the first lens. For example, in the fourth lens pair embodiment described above with reference to FIG. 6, the outer regions 423, 433 of the left and right lenses are similar to one another but are oriented at 90 degrees with respect to one another. A lens pair similar to the fourth embodiment could be cut from a single design of lens puck provided with an outer region similar to that of one of the left or right outer regions 423, 433 using the method illustrated in FIG. 16. A first lens could be cut from a first lens puck and a corresponding second lens could be cut from a substantially identical lens puck rotated about an axis of the lens puck by an angle of 90 degrees relative to the orientation of the first lens.

In other embodiments, lenses in accordance with the present disclosure may have outer regions comprising spiral power maps of the type disclosed by PCT application number PCT/GB2021/051038, the entire contents of which is incorporated by reference. Such power maps provide myopia control stimulus in the form of defocus. For example, a seventh lens pair embodiment, shown in FIG. 12, has a left lens 820 having an optic zone 821 formed by a myopia-correcting central region 822 surrounded by an outer region 823 and a right lens 830 having an optic zone 831 formed by a myopia-correcting central region 832 surrounded by an outer region 833, wherein the outer region 823, 833 of each lens is formed by the superposition of two spiral power maps having opposing twist directions, in accordance with the disclosure of PCT/GB2021/051038. Each power map comprises a spiral with an add power that varies substantially periodically both radially outwards from and angularly about an optical axis of the lens. The add power may focus incoming light that is parallel to the optical axis (i.e., light from a distance) to a point on the optical axis of the lens, wherein the point is in front of the retina when the lens is worn by a lens wearer. The add power may focus incoming light that is parallel to the optical axis (i.e., light from a distance) to a set of points that are situated at a first distance from the optical axis.

The resulting power maps of each of the outer regions 823, 833, which are shown in FIG. 12, are determined by the superposition of the two spiral power maps and comprise an array of alternating myopia-controlling subregions 824, 834 and myopia-correcting subregions 825, 835 that surround the myopia-correcting central region 822, 832. In the embodiment shown in FIG. 12, the power map of right outer region 833 is a mirror image of the power map of the left outer region 823 so that the respective left and right outer regions 823, 833 have complementarily arranged myopia-controlling subregions 824, 834 and myopia-correcting subregions 825, 835.

It should be noted that the lenses of each lens pair described above have been assigned to be either a left lens or a right lens for the purposes of the corresponding description only. In each case, the lens designated as the left lens is suitable for use as the right lens when the lens designated as the right lens is used as the left lens.

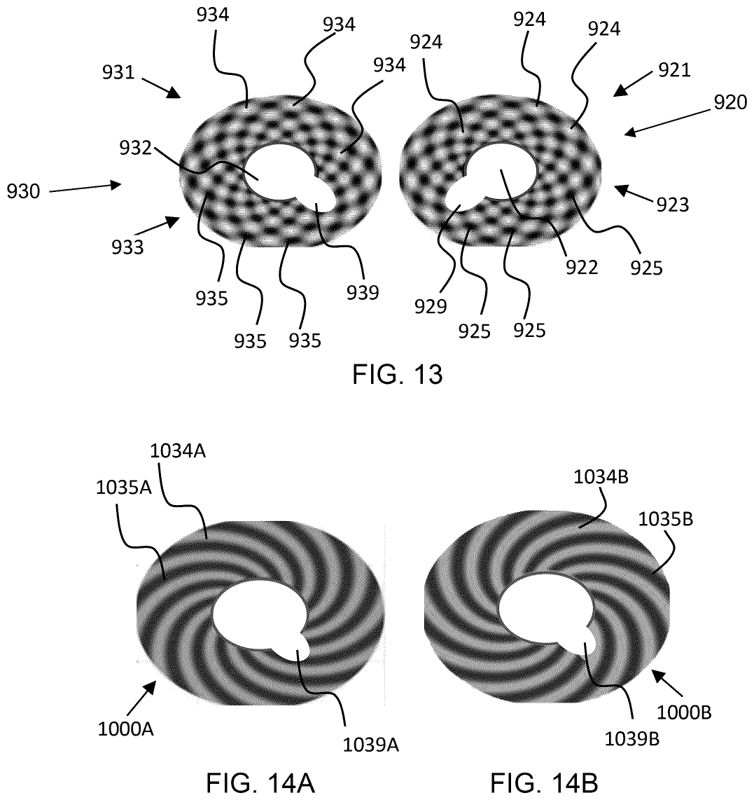

Some embodiments of the present disclosure may include lenses incorporating a progressive zone for near viewing. As will be understood by the skilled person, a progressive zone generally incorporates an add power gradient in a channel in the lens that extends generally downwards and in a nasal direction so as to accommodate for the binocular convergence and downward gaze angle associated with near viewing scenarios, such as reading. An eighth lens pair embodiment is shown in FIG. 13. The eighth lens pair embodiment is substantially the same as the seventh lens pair embodiment shown in FIG. 12 in that the eighth embodiment has a left lens 920 having an optic zone 921 formed by a myopia-correcting central region 922 surrounded by an outer region 923 and a right lens 930 having an optic zone 931 formed by a myopia-correcting central region 932 surrounded by an outer region 933, wherein the outer region 923, 933 of each lens is formed by the superposition of two spiral power maps having opposing twist directions. However, in the eight embodiment the optic zone 921, 931 of each lens comprises a progressive zone 929, 939. As can be seen, the respective progressive zones 929, 939 are free from myopia correcting subregions 925, 935 and myopia controlling subregions 924, 934. To produce an optic zone having this configuration, embodiments of the disclosure may comprise superposed spiral power maps of the type shown in FIG. 14A and FIG. 14B. A first power map 1000A is shown in FIG. 14A, which comprises a region 1039A corresponding to the progressive zone removed from the spiral pattern of myopia-controlling arms 1034A and myopia-correcting arms 1035A. A second power map 1000B is shown in FIG. 14B. The second power map 1000B comprises a region 1039B corresponding to the progressive zone and is arranged in substantially the same way as the first power map 1000A except that the orientation of the spiral pattern of myopia-controlling arms 1034B and myopia-correcting arms 1035B has been reversed. Superposition of the first and second power maps 1000A, 1000B results in the power map of the right optic zone 931 of the eighth embodiment, which is shown in FIG. 13. The first power map 1000A may be provided on the front of a lens and the second power map 1000B may be provided on the rear of a lens (or vice versa). It will be understood that the power maps required to form the optic zone 921 of the left lens are mirror images of those shown in FIG. 14A and FIG. 14B.

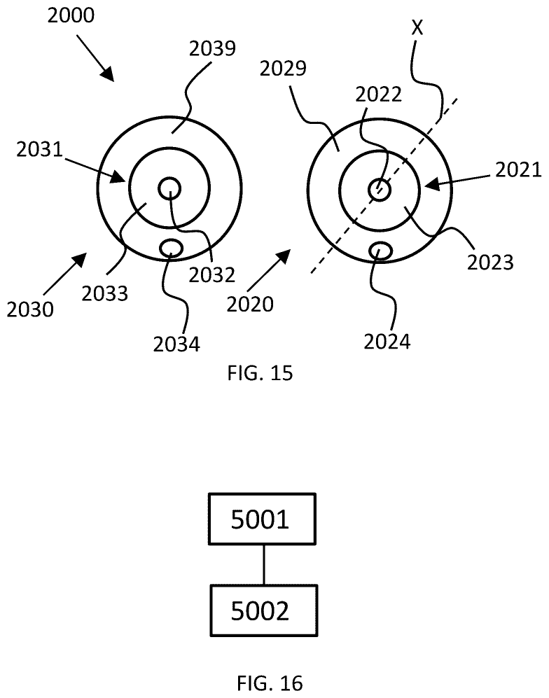

FIG. 15 shows an example of eyewear 2000 according to the present disclosure that comprises a pair of respective left and right contact lenses 2020, 2030 configured for use in slowing progression of myopia. Similar to the lenses 20, 30 of the spectacles 1 shown in FIG. 1, each contact lens 2020, 2030 comprises an optic zone 2021, 2031 having a myopia-correcting central region 2022, 2032 and an outer region 2023, 2033 surrounding the central region 2021, 2031. The optical axis X of the left lens 2020 is shown schematically in FIG. 1 for the purpose of illustration.

The optical axis X in this case lies along the centreline of the lens 2020.

In addition to an optic zone 2021, 2031, each of the lenses 2020, 2030 comprises a peripheral zone 2029, 2039, that, in use, sits over the iris of the wearer. The peripheral zones 2029, 2039 provide mechanical functions, including increasing the overall size of the contact lenses 2020, 2030, thereby making the lenses 2020, 2030 easier to handle, providing ballasting to prevent rotation of the lenses 2020, 2030 in use, and providing a shaped region that improves comfort for the wearer of the contact lenses 2020, 2030.

As shown schematically in FIG. 15, each of the contact lenses 2020, 2030 comprises a ballast in the form of wedge 2024, 2034. The ballasts ensure that the contact lenses 2020, 2030 remain correctly oriented when positioned on the eye of a wearer, such that the myopia controlling subregions and the myopia correcting subregions of each of the contact lenses 2020, 2030 are complementarily arranged with respect to one another.

Similar to the lenses 20, 30 of the spectacles 1 shown in FIG. 1, the outer regions 2023, 2033 of the contact lenses comprise myopia-controlling subregions and myopia-correcting subregions. The arrangement of myopia-controlling subregions and myopia-correcting subregions within the outer regions 2023, 2033 of the contact lenses may correspond to any of the outer region arrangements described above with reference to FIGS. 1 to 12.

Whilst in the foregoing description, integers or elements are mentioned which have known obvious or foreseeable equivalents, then such equivalents are herein incorporated as if individually set forth. Reference should be made to the claims for determining the true scope of the present disclosure, which should be construed as to encompass any such equivalents. It will also be appreciated by the reader that integers or features of the disclosure that are described as advantageous, convenient or the like are optional, and do not limit the scope of the independent claims. Moreover, it is to be understood that such optional integers or features, whilst of possible benefit in some embodiments of the disclosure, may not be desirable and may therefore be absent in other embodiments.

Further aspects of the disclosure are set out in the following numbered clauses:

Clause 1. Eyewear for slowing the progression of myopia, the eyewear comprising a left lens and a right lens pair, wherein a position of at least one myopia control stimulator region of predefined size and position on the left lens corresponds in size and position to a respective at least one distance vision region in the right lens, and at least one myopia control stimulator region of predefined size and position on the right lens corresponds in size and position to a respective at least one distance vision region in the left lens; the myopia control stimulator region provides a myopia control stimulus; the eyewear may be configured such that, as the eyes of a wearer of the eyewear view an object, the or each myopia control stimulator region subject to the gaze of one of the eyes corresponds to a distance vision region subject to the gaze of the other of the eyes.

Clause 2. Eyewear according to clause 1, wherein the or each myopia control stimulator region is disposed within an outer myopia control stimulator region.

Clause 3. Eyewear according to clause 1 or clause 2, wherein the or each distance vison region is more extensive than the corresponding at least one myopia control stimulator region.

Clause 4. Eyewear according to clause 1 or clause 2, wherein the or each distance vison region is up to 20% less extensive than the corresponding at least one myopia control stimulator region.

Clause 5. Eyewear for slowing the progression of myopia, the eyewear comprising a left lens and a right lens, the left and right lens including respective optic zones respectively comprising:
a respective central region centered on a respective optical axis and arranged to provide a respective base power when the eyewear is worn, and
a respective outer region disposed outwardly of the respective central region wherein:
the outer region of the left lens comprises at least:
   a first left lens subregion, having a first shape and size and disposed at a first position with respect to the lens optical axis, and arranged to provide a myopia control stimulus when the eyewear is worn; and
   a second left lens subregion having a second shape and size and disposed at a second position with respect to the lens optical axis, and arranged to provide distance vision when the eyewear is worn; and
the outer region of the right lens comprises at least:
   a first right lens subregion, having a shape and size the same as or closely similar to the first shape and size of the first left lens subregion, and disposed at a position with respect to the right lens optical axis that is the same as or closely similar to the first position of the first left lens subregion with respect to the left lens optical axis, and arranged to provide distance vision when the eyewear is worn; and
   a second right lens subregion having a shape and size the same as or closely similar to the second shape and size of the second left lens subregion, and disposed at a position with respect to the right lens optical axis that is the same as or closely similar to the second position of the second left lens subregion with respect to the left lens optical axis, and arranged to provide a myopia control stimulus when the eyewear is worn.

Clause 6. Eyewear according to clause 1 or clause 5, wherein the myopia control stimulus comprises one or more of: defocus, contrast attenuation, and manipulation of the spectrum of visible light.

Clause 7. Eyewear according to clause 5 or clause 6, wherein, for each lens, the first and second subregions are arranged concentrically with respect to the central region.

Clause 8. Eyewear according to any of clauses 5 to 7, wherein, for each lens, the first and second subregions are generally annular in shape.

Clause 9. Eyewear according to clause 5 or clause 6, wherein, for each lens, the first and second subregions are circumferentially spaced around the central region.

Clause 10. Eyewear according to any of clauses 5 to 9, wherein the first subregion of the left lens is the same size as the first subregion of the right lens.

Clause 11. Eyewear according to any of clauses 5 to 10, wherein the second subregion of the left lens is the same size as the second subregion of the right lens.

Clause 12. Eyewear according to any of clauses 5 to 11, wherein:
the optic zone of the left lens is configured such that:
   each respective first lens subregion forms part of a first plurality of lens subregions within the outer region, each lens subregion of the first plurality providing a myopia control stimulus at a first plurality of positions with respect to the respective optical axis;
   each respective second lens subregion forms part of a second plurality of lens subregions within the outer region, each lens subregion of the second plurality being arranged to provide distance vision at a second plurality of positions with respect to the respective optical axis,
the optic zone of the right lens is configured such that:
   each respective first lens subregion forms part of a first plurality of lens subregions within the outer region, each lens subregion of the first plurality being arranged to provide distance vision at a first plurality of positions with respect to the respective optical axis,
   each respective second lens subregion forms part of a second plurality of lens subregions within the outer region, each lens subregion of the second plurality providing a myopia control stimulus at a second plurality of positions with respect to the respective optical axis;
the first and second pluralities of positions with respect to the optical axis of the left lens being the same as or closely similar to the respective first and second pluralities of positions with respect to the optical axis of the right lens;
and each right lens subregion having a shape and size the same as or closely similar to the corresponding left lens subregion.

Clause 13. Eyewear according to clause 12, wherein, for each lens, subregions of the first plurality are interposed between subregions of the second plurality.

Clause 14. Eyewear according to clause 12 or clause 13, wherein, for each lens, the subregions of the first plurality and the subregions of the second plurality are arranged concentrically with respect to the respective central region.

Clause 15. Eyewear according to any of clauses 12 to 14, wherein, for each lens, the subregions of the first plurality and the subregions of the second plurality are arranged circumferentially around the central region.

Clause 16. Eyewear according to any of clauses 12 to 15, wherein, for at least one of the left and right lenses, the subregions providing the myopia control stimulus comprise one or more lenslets configured to provide the myopia control stimulus.

Clause 17. Eyewear according to clause 16, wherein each lens comprises a primary lens and the optic zone comprises a region of the primary lens having a base power and a plurality of lenslets distributed across the region of the primary lens having the base power, wherein the lens subregions providing distance vision are provided by portions of the region of the primary lens having the base power between the lenslets.

Clause 18. Eyewear according to any of clauses 12 to 17, wherein the myopia control stimulus is defocus provided by an add power and the optic zone of each lens is configured such that:
the outer region corresponds to a region of the lens where a first surface of the lens varies across the lens to form a first surface power map, and
the first surface power map comprises a spiral with an add power that varies substantially periodically both radially outwards from and angularly about an optical axis of the lens.

Clause 19. Eyewear according to clause 18, wherein the optic zone of each lens is further configured such that:
the outer region corresponds to a region of the lens where a second surface of the lens varies across the lens to form a second surface power map;
the second surface power map comprises a spiral, with an add power that varies substantially periodically radially outwards from and angularly about the optical axis of the lens.

Clause 20. Eyewear according to clause 19, wherein the spirals provided by the first and second surface power maps twist in opposing directions.

Clause 21. Eyewear according to any of clauses 1 to 20, wherein the eyewear is configured such that, in use, the left and right lenses are spaced-apart from a wearer's eyes.

Clause 22. Eyewear according to clause 21, wherein the eyewear is a pair of spectacles.

Clause 23. Eyewear according to clause 21 or 22, wherein, for each lens, the first subregion or myopia control stimulator region has a minimum dimension in a nominal plane of the lens of at least 3 millimetres.

Clause 24. Eyewear according to any of clauses 21 to 23, wherein, for each lens, the second subregion or distance vision region has a minimum dimension in a nominal plane of the lens of at least 3 millimetres.

Clause 25. A pair of lenses suitable for use as the left and right lenses of the eyewear of any of clauses 1 to 24.

Clause 26. Eyewear according to any of clauses 1 to 20, wherein the left and right lenses are contact lenses, the left lens being a left contact lens and the right lens being a right contact lens, the left and right contact lenses each comprising a rotational stabilizer to maintain the correspondence relative to the eyes of a wearer between the first and second positions of the left lens and the respective first and second positions of the right lens.

Clause 27. A method of making a pair of lenses for eyewear, the method comprising:
providing a first lens puck having an optic zone comprising:
   a central region providing a base power and defining a central axis,
   an outer region surrounding the central region, the outer region comprising at least a first subregion and a second subregion, wherein one of the first subregion or second subregion provides a myopia control stimulus,
removing material from the first lens puck to form a first lens from the first lens puck at a first angle with respect to the central axis of the first lens puck, the first lens being shaped such that an optical axis of the first lens coincides with the central axis of the lens puck,
providing a second lens puck having an optic zone that is substantially identical to the optic zone of the first lens puck,
removing material from the second lens puck to form a second, complementarily shaped lens from the second lens puck at a second angle with respect to the central axis of the second lens puck,
wherein the first angle and the second angle are chosen such that the first and second lenses are suitable for use as the respective left and right lenses of the eyewear of any of clauses 21 to 24.

1. An eyewear for slowing the progression of myopia, the eyewear comprising a left lens and a right lens, the left and right lens including respective optic zones respectively comprising:
a respective central region centered on a respective optical axis and arranged to provide a respective base power when the eyewear is worn, and
a respective outer region disposed outwardly of the respective central region, the outer region comprising:
at least a respective first subregion that provides one of a first optical property or a second optical property at a first position with respect to the respective optical axis, and
at least a respective second subregion that provides the other one of the first optical property or the second optical property at a second position with respect to the respective optical axis,
the first and second positions with respect to the optical axis of the left lens correspond with the respective first and second positions with respect to the optical axis of the right lens,
wherein:
the outer regions of the left lens and the right lens are complementarily arranged such that the first and second subregions of the left lens have different optical properties to the first and second subregions of the right lens,
the first optical property is a myopia control stimulus, and
the second optical property is an optical power for providing distance vision when the eyewear is worn.

2. The eyewear according to claim 1, wherein the myopia control stimulus comprises one or more of: defocus, contrast attenuation, and manipulation of the spectrum of visible light.

3. The eyewear according to claim 1, wherein, for each lens, the first and second subregions are arranged concentrically with respect to the central region.

4. The eyewear according to claim 1, wherein, for each lens, the first and second subregions are generally annular in shape.

5. The eyewear according to claim 1, wherein, for each lens, the first and second subregions are circumferentially spaced around the central region.

6. The eyewear according to claim 1, wherein the first subregion of the left lens is the same size as the first subregion of the right lens.

7. The eyewear according to claim 1, wherein the second subregion of the left lens is the same size as the second subregion of the right lens.

8. The eyewear according to claim 1, wherein:
the optic zone of each of the left lens and the right lens is configured such that:
each respective first subregion forms part of a first plurality of subregions within the outer region, each subregion of the first plurality providing the one of the first optical property or the second optical property at a first plurality of positions with respect to the respective optical axis;
each respective second subregion forms part of a second plurality of subregions within the outer region, each subregion of the second plurality providing the other one of the first optical property or the second optical property at a second plurality of positions with respect to the respective optical axis,
the first and second pluralities of positions with respect to the optical axis of the left lens correspond with the respective first and second pluralities of positions with respect to the optical axis of the right lens, wherein:
the first and second pluralities of subregions of the left lens have different respective optical properties to the respective optical properties of the corresponding first and second pluralities of subregions of the right lens.

9. The eyewear according to claim 8, wherein, for each lens, subregions of the first plurality are interposed between subregions of the second plurality.

10. The eyewear according to claim 8, wherein, for each lens, the subregions of the first plurality and the subregions of the second plurality are arranged concentrically with respect to the respective central region.

11. The eyewear according to claim 8, wherein, for each lens, the subregions of the first plurality and the subregions of the second plurality are arranged circumferentially around the central region.

12. The eyewear according to claim 8, wherein, for at least one of the left and right lenses, the subregions providing the myopia control stimulus comprise one or more lenslets configured to provide the myopia control stimulus.

13. The eyewear according to claim 12, wherein each lens comprises a primary lens and the optic zone comprises a region of the primary lens having a base power and a plurality of lenslets distributed across the region of the primary lens having the base power, wherein the subregions of the optic zone not providing the myopia control stimulus are provided by portions of the region of the primary lens having the base power between the lenslets.

14. The eyewear according to claim 8, wherein the myopia control stimulus is defocus provided by an add power and the optic zone of each lens is configured such that:
the outer region corresponds to a region of the lens where a first surface of the lens varies across the lens to form a first surface power map, and
the first surface power map comprises a spiral with an add power that varies substantially periodically both radially outwards from and angularly about an optical axis of the lens.

15. The eyewear according to claim 14, wherein the optic zone of each lens is further configured such that:
the outer region corresponds to a region of the lens where a second surface of the lens varies across the lens to form a second surface power map;
the second surface power map comprises a spiral, with an add power that varies substantially periodically radially outwards from and angularly about the optical axis of the lens.

16. The eyewear according to claim 15, wherein the spirals provided by the first and second surface power maps twist in opposing directions.

17. The eyewear according to claim 1, wherein the eyewear is configured such that, in use, the first and second lenses are spaced-apart from a wearer's eyes.

18. The eyewear according to claim 17, wherein the eyewear is a pair of spectacles.

19. The eyewear according to claim 17, wherein the first subregion has a minimum dimension in a nominal plane of the lens of at least 3 millimetres.

20. The eyewear according to claim 17, wherein the second subregion has a minimum dimension in a nominal plane of the lens of at least 3 millimetres.

21. A pair of lenses suitable for use as the left and right lenses of the eyewear of claim 1.

22. The eyewear according to claim 1, wherein the left and right lenses are contact lenses, the left lens being a left contact lens and the right lens being a right contact lens, the left and right contact lenses each comprising a rotational stabilizer to maintain the correspondence relative to the eyes of a wearer between the first and second positions of the left lens and the respective first and second positions of the right lens.

23. A method of making a pair of lenses for eyewear, the method comprising:
providing a first lens puck having an optic zone comprising:
a central region providing a base power and defining a central axis,
an outer region surrounding the central region, the outer region comprising at least a first subregion and a second subregion, wherein one of the first subregion or second subregion provides a myopia control stimulus,
removing material from the first lens puck to form a first lens from the first lens puck at a first angle with respect to the central axis of the first lens puck, the first lens being shaped such that an optical axis of the first lens coincides with the central axis of the lens puck,
providing a second lens puck having an optic zone that is substantially identical to the optic zone of the first lens puck,
removing material from the second lens puck to form a second, complementarily shaped lens from the second lens puck at a second angle with respect to the central axis of the second lens puck,
wherein the first angle and the second angle are chosen such that the first and second lenses are suitable for use as the respective left and right lenses of the eyewear of claim 17.

24. An eyewear for slowing the progression of myopia, the eyewear comprising a left lens and a right lens pair, wherein at least one myopia control stimulator region of predefined size and position on the left lens corresponds in size and position to a respective at least one distance vision region in the right lens, and at least one myopia control stimulator region of predefined size and position on the right lens corresponds in size and position to a respective at least one distance vision region in the left lens.

25. The eyewear according to claim 24 configured such that, as the eyes of a wearer of the eyewear view a distant object, the or each myopia control stimulator region subject to the gaze of one of the eyes corresponds to a distance vision region subject to the gaze of the other of the eyes.

26. The eyewear according to claim 24, wherein the or each myopia control stimulator region is disposed within an outer myopia control stimulator region.

27. The eyewear according to claim 24, wherein the or each distance vison region is more extensive than the corresponding at least one myopia control stimulator region.

28. The eyewear according to claim 24, wherein the or each distance vison region is up to 20% less extensive than the corresponding at least one myopia control stimulator region.

29. An eyewear for slowing the progression of myopia, the eyewear comprising a left lens and a right lens, the left and right lens including respective optic zones respectively comprising:
a respective central region centered on a respective optical axis and arranged to provide a respective base power when the eyewear is worn, and
a respective outer region disposed outwardly of the respective central region wherein:
the outer region of the left lens comprises at least:
a first left lens subregion, having a first shape and size and disposed at a first position with respect to the lens optical axis, and arranged to provide a myopia control stimulus when the eyewear is worn; and
a second left lens subregion having a second shape and size and disposed at a second position with respect to the lens optical axis, and arranged to provide distance vision when the eyewear is worn; and
the outer region of the right lens comprises at least:
a first right lens subregion, having a shape and size the same as or closely similar to the first shape and size of the first left lens subregion, and disposed at a position with respect to the right lens optical axis that is the same as or closely similar to the first position of the first left lens subregion with respect to the left lens optical axis, and arranged to provide distance vision when the eyewear is worn; and
a second right lens subregion having a shape and size the same as or closely similar to the second shape and size of the second left lens subregion, and disposed at a position with respect to the right lens optical axis that is the same as or closely similar to the second position of the second left lens subregion with respect to the left lens optical axis, and arranged to provide a myopia control stimulus when the eyewear is worn.
